(19) United States
(12) Patent Application Publication
(10) Pub. No.: US 2022/0298184 A1
(43) Pub. Date: Sep. 22, 2022

(54) SELF-AGGREGATING HYDROUS PHOSPHOLIPID AND PREPARATION METHOD THEREOF

(71) Applicants: INNER MONGOLIA BOBEYMAN TECHNOLOGY CO. LTD, Hohhot (CN); SHANGHAI TAIWEI PHARMACEUTICAL CORP. LTD, Shanghai (CN)

(72) Inventor: Ziqian Xu, Hohhot (CN)

(21) Appl. No.: 17/830,423

(22) Filed: Jun. 2, 2022

Related U.S. Application Data
(63) Continuation of application No. PCT/CN2020/135902, filed on Dec. 11, 2020.

(30) Foreign Application Priority Data
May 26, 2020 (CN) 202010455248.2
May 26, 2020 (CN) 202010460588.4

(51) Int. Cl. C07F 9/10; C11B 13/00; A23D 7/005; A23D 7/04

(52) U.S. Cl. CPC C07F 9/103; C11B 13/00; C07F 9/106; A23D 7/0053; A23D 7/04

(57) ABSTRACT

The invention belongs to the technical field of phospholipid processing, in particular to a self-aggregating hydrous phospholipid and a preparation method thereof. The self-aggregating hydrous phospholipid, the main components of the self-aggregating hydrous phospholipid are phospholipids, oil and water, the water content is 70-80 g/100 g, and the acetone-insoluble content on a dry basis is 92.5-95.5 g/100 g. Preferably, the self-aggregating hydrous phospholipid is a brown translucent fluid. The present invention is used to overcome the defects of low acetone-insoluble content of the hydrous phospholipid prepared by the existing method and the long-term dependence of the industry on the solvent method to prepare powder phospholipid, and to solve the technical problem that the hydration method powder phospholipid cannot realize industrial production.

### CROSS-REFERENCE TO RELATED APPLICATION

The present application is a continuation application of PCT patent application No. PCT/CN2020/135902 filed on Dec. 11, 2020, which claims the benefit of Chinese Patent Application Nos. 202010460588.4 and 202010455248.2, both filed on May 26, 2020, each of which is incorporated by reference herein in its entirety.

### TECHNICAL FIELD

The invention belongs to the technical field of phospholipid processing, in particular to a self-aggregating hydrous phospholipid and a preparation method thereof.

### BACKGROUND

The raw material for phospholipid processing is soybean oil sediments (also known as “Lecithin gum” or “soybean oil feet” or “soybean oil bottoms”), which is a by-product of the hydration and degumming process in the refining process of soybean oil in the field of oil processing, also known as hydration oil sediments. The main components of soybean oil sediments are phospholipids 30-45 g/100 g, soybean oil 20-30 g/100 g, moisture 30-50 g/100 and some trace components, of which the trace components are metal ions, such as calcium, magnesium and iron. The ions exist in the form of phospholipid metal salts; taking iron ions as an example, in terms of acetone insoluble matter, it is usually 50-100 mg/kg, and in individual cases it is as high as 150 mg/kg or more.

There are two main industrialized phospholipid processing methods.

One method is to prepare concentrated phospholipids by hydration method, that is, after hydrating and extracting soybean oil sediments from soybean crude oil, the concentrated phospholipids are obtained after direct drying and dehydration. Concentrated phospholipids are also called fluid phospholipids because of their fluidity. The content of acetone insolubles on dry basis of concentrated phospholipids is 60-65 g/100 g.

Another method is to prepare powder phospholipids by solvent method, that is, by using soybean oil sediments or concentrated phospholipids as raw materials, and extracting and removing oil with acetone, to obtain powder phospholipids with a dry-base acetone-insoluble content of 95-98 g/100 g.

At present, the main products on the market are concentrated phospholipids, while powder phospholipids account for less than 5% of the market.

Although soybean oil sediments are overwhelmingly processed into concentrated phospholipids, the concentrated phospholipids have major drawbacks.

For example, the journal documents “Preparation Process of Soybean Phospholipid Concentrate” (Hu Xingzhong. Preparation Process of Soybean Phospholipid Concentrate [J]. China Oils and Fats, 2007, 32(9): 20-21) and the journal “Preparation Technology and Practice of Concentrated Phospholipid” (Hu Qingtao et al. Preparation technology and practice of concentrated phospholipid [J]. China Oils and Fats, 2002, 27(1): 39-40) introduced the method of producing concentrated phospholipids by dehydration and oxidative bleaching using hydrated oil sediments as raw materials.

The disadvantage of this process is that the acetone-insoluble content of concentrated phospholipids is too low (60-65 g/100 g), and chemical bleaching is required, and at the same time, its market price is only 40.00 yuan/ton. There is a big difference in price between concentrated phospholipids and powder phospholipids which is 40,000 yuan/ton.

Patent application CN103665029A discloses a method for preparing soybean powder phospholipid. In the method, acetone is used as a solvent to extract the hydrated oil sediments, the acetone insoluble matter is separated, and then the acetone insoluble matter is dried under low temperature vacuum to remove the solvent, and finally the powdered phospholipid is obtained.

The disadvantage of this method is the use of acetone solvent, high production cost, environmental pollution, and solvent residues, which will lead to food safety hazards, and it is difficult to popularize widely. Therefore, this method cannot promote the upgrading of product structure from concentrated phospholipids to powder phospholipids in the field of oil processing, nor can it be improved the current situation of high oil refining loss.

At present, there are many defects in the research of preparing phospholipid by hydration method. For example, patent application CN107325125A discloses a method for preparing hydrated phospholipid from soybean oil sediments and the obtained hydrated phospholipid. The method includes the following operation steps: taking soybean oil sediments and adding softened water, after the water is mixed evenly, it is left to stand for chromatography; after the chromatography, the temperature is controlled at 85-95° C., and centrifugation is performed to obtain hydrated phospholipids, and the acetone-insoluble content can reach 90-92%. The patent has the following defects:

(1) Hydrated Phospholipids have a Low Dry Basis Acetone Insoluble Content.

The patent is a homogeneous hydration method, that is, the oil sediments and water should be mixed evenly, and emulsification will inevitably occur when mixing evenly. If the emulsification is serious, it is difficult to separate the phospholipids and oils.

In order to avoid serious emulsification, the patent takes two measures. First, strictly control the amount of water added, which is 0.25-0.74 times the weight of the oil sediment; second, add sodium hydroxide or sulfuric acid to be used as a demulsifier. The problem brought about by the above measures is that the main components of phospholipids, oils and phospholipid metal salts in soybean oil sediments have not been effectively separated, and the dry acetone-insoluble content of hydrated phospholipids is only up to 92%. Compared with the solvent method, there is still a certain gap.

(2) Cannot be Industrially Applied.

The hydrated phospholipid is concentrated and dehydrated, added with preservatives, pasteurized and packaged to obtain a hydrous phospholipid product with a water content of 22.5-41.2%. However, this product does not meet the national standard “GB28401 Food Additive Phospholipids” that the moisture should not exceed 2%, so it cannot be sold.

If it is dried according to the existing method for preparing powdered phospholipids, the time is too long, the production capacity is too low, there is no feasibility of industrial production, and it cannot be sold or further processed, so that it cannot be industrially applied.

Another prior art of extracting phospholipids by hydration has been published in a journal article “Separation and Purification of Soybean Phosphatides in Liquid Crystal Phase” (Li Ziming et al. Separation and Purification of Soybean Phosphatides in Liquid Crystal Phase [J]. Journal of the Chinese Cereals and Oils Association) Journal, 2007, 22(1):31-32).

This method has the following technical defects:

(1) The dry acetone-insoluble content of the liquid crystal phospholipid is low. The amount of water added is 0.67 times the oil sediments, and the dry acetone-insoluble content of the obtained liquid crystal phospholipid is only 86.05%, by using the homogeneous hydration method, which is the same as the defect of hydrated phospholipid;

(2) It cannot be used industrially. The drying problem of liquid crystal phospholipids is the same as that of hydrated phospholipids. Although liquid crystalline phospholipids can be converted into powdered phospholipids by intermittent vacuum drying, the drying time is too long, and the color of the phospholipid products is too dark to be applied to industrial production.

Patent application CN102517148A discloses a two-step decolorization method for phospholipids, which adopts a two-step decolorization method of hydrogen peroxide bleaching and silica gel adsorption.

The disadvantages of this method are:

(1) The use of chemical bleaching and decolorization will cause oxidation by-products of phospholipids, destroy the naturalness of phospholipids, and present food safety risks, which does not conform to the general trend of “green” development.

(2) The effect of silica gel adsorption and decolorization is very poor, and the invalid silica gel becomes waste residue, which is not conducive to environmental protection.

(3) The beneficial antioxidant components in phospholipids are destroyed by bleaching, the antioxidant properties and nutritional value of phospholipids are reduced, and the shelf life is shortened.

At present, the research of metal ions in phospholipids is limited to the detection of content. Soybean oil sediments contains a certain amount of metal ions such as calcium, magnesium and iron, which exist in the form of phospholipid metal salts, referred to as phospholipid salts. Among phospholipid salts, phospholipid iron salts are the most representative.

“Phospholipid composition and properties of soybean oil” (Rao Tianguo. Phospholipid composition and properties of soybean oil [J]. Food Processing, 1982, 2:62) reported that the hydratable phospholipid of soybean crude oil contains 150 mg/kg of iron ions, these iron ions will eventually be transferred to the hydrated oil sediments.

“Determination of phospholipids composition in crude soybean oil from different sources by nuclear magnetic resonance and comparison of phosphatidic acid content” (Yu Le et al. Determination of phospholipids composition in crude soybean oil from different sources by nuclear magnetic resonance and comparison of phosphatidic acid content [J]. China Oils and Fats, 2017, 42 (1): 132) reported: the content of metal ions in soybean crude oil. However, there is no report on how to remove phospholipid iron salts from soybean oil sediments.

In the field of phospholipid processing, from the product point of view, the replacement of concentrated phospholipids with powdered phospholipids is the future direction.

From the method point of view, hydration method instead of solvent method is the future direction.

Although some hydration methods have been studied at present, the purity of the phospholipids prepared by the hydration method is still not high enough, the color improvement has not been separated from the method of chemical bleaching, the dehydration efficiency of the hydration method has not yet reached the level of industrialization, and there are some deficiencies in the integrity and continuity of the process.

Therefore, it is very necessary to develop a self-aggregation hydrous (water-containing) phospholipids that can solve the above technical problems and a method for separating self-aggregation hydrous phospholipids from soybean oil sediments.

### SUMMARY

The first object of the present invention is to provide a self-aggregating hydrous phospholipid. The self-aggregating hydrous phospholipid of the present invention has the following advantages: the water content reaches saturation, the content of acetone-insoluble matter on a dry basis is the highest among all known hydration methods, and the content of acetone-insoluble matter on a dry basis is close to or even reaches the level that of solvent-based powder phospholipids.

The self-aggregating hydrous phospholipid is an intermediate product necessary for preparing hydration powder phospholipid.

From the perspective of industry development, hydration-based powdered phospholipids will eventually replace solvent-based powdered phospholipids and become mainstream products to eliminate environmental pollution caused by organic solvents and potential food safety hazards caused by solvent residues, while reducing production costs.

The invention solves the technical problem that the prior art cannot prepare high-purity hydrous phospholipids and powder phospholipids from soybean oil sediments by a hydration method.

The self-aggregating hydrous phospholipids have not been reported in the field of phospholipid processing and related research.

The second object of the present invention is to provide a method for separating self-aggregated hydrous phospholipids from soybean oil sediments.

The present invention is used to overcome the defects of low acetone-insoluble content of the hydrous phospholipid prepared by the existing method and the long-term dependence of the industry on the solvent method to prepare powder phospholipid, and to solve the technical problem that the hydration method powder phospholipid cannot realize industrial production.

The purpose of the self-aggregating hydrous phospholipid prepared by the present invention is to prepare hydration powder phospholipid. The acetone-insoluble content of the self-aggregated hydrous phospholipids is as high as 92.5-95.5 g/100 g, the color is natural yellow, and it is non-bleaching and solvent-free. The self-aggregating hydrous phospholipid of the present invention can replace the solvent-based powdered phospholipid, avoid environmental pollution and food safety hazards caused by the solvent-based powdered phospholipid, and the production cost of the hydration-based powdered phospholipid is far lower than that of the solvent-based powdered phospholipid.

The method for separating self-aggregated hydrous phospholipids from soybean oil sediments has not been reported in the field of phospholipid processing and related research.

The third object of the present invention is to provide the application of the self-aggregating hydrous phospholipid in the preparation of powder phospholipid.

For realizing the above purpose, the technical scheme provided by the invention is as follows:

A self-aggregating hydrous phospholipid, the main components of the self-aggregating hydrous phospholipid are phospholipids, oil and water, the water content is 70-80 g/100 g, and the acetone-insoluble content on a dry basis is 92.5-95.5 g/100 g.

Preferably, the self-aggregating hydrous phospholipid is a brown translucent fluid.

The self-aggregating hydrous phospholipids refer to aggregates formed by spontaneous combination and spontaneous aggregation of phospholipids in soybean oil sediments and water.

The present invention also relates to a method for preparing self-aggregating hydrous phospholipids, comprising the following steps: soaking soybean oil sediments in water to obtain saturated water-absorbing oil sediments, and naturally sinking.

The soaking refers to that soybean oil sediment is a dispersed phase in water, and water is a continuous phase, which constitutes a soaking system.

At the end of the soaking, the water absorption of the phospholipids in the saturated water-absorbing oil sediments reaches saturation, and the water content of the phospholipids reaches 70-80 g/100 g.

Preferably, the mass ratio of the soybean oil sediment to water is 1:1-3.5.

When the water is less than 1.0 times the weight of the oil sediment, soybean oil sediment cannot be effectively soaked in water, which affects the combination of phospholipid and water.

When the water is more than 3.5 times the mass of the oil sediment, although it is beneficial to soak the soybean oil sediment, the cost of water, energy consumption and the volume of the equipment are all increased.

Preferably, the soaking temperature is 60-95° C.

In water at 0° C. to 100° C., phospholipids can combine with water, and the higher the temperature, the higher the binding efficiency. Therefore, increasing the water temperature can shorten the soaking time.

However, boiling water is not conducive to the stabilization of self-aggregated hydrous phospholipids, and also wastes energy.

Therefore, the temperature of the soaking is preferably 60-95° C.

The temperature above 60° C. is the sterilization temperature, which can prevent the oil sediments from deteriorating during soaking, and the temperature below 95° C. can prevent the water from boiling.

Preferably, the soaking time is 1-3 h.

The soaking time refers to the time required to obtain saturated water-absorbing oil sediments, that is, from the time the soybean oil sediments are soaked in water in a granular form, until the brown self-aggregating hydrous phospholipid begins to appear in the soybean oil sediments.

The soybean oil sediment in soaking is yellow, and the self-aggregating hydrous phospholipid is brown, so it could be visually judged whether the soaking had reached the end time.

Preferably, the soaking is standing soaking.

During soaking, stirring should not be performed to prevent emulsification.

Preferably, before soaking, the soybean oil sediment is dispersed into granules in water with stirring.

More preferably, the particle size of the soybean oil sediment particles is less than or equal to 5 mm.

More preferably, the particle size of the soybean oil sediment particles is 0.3-3 mm.

The smaller the particle size of soybean oil sediments, the larger the contact area between oil sediments and water, which is more conducive to improving the mass transfer and heat transfer efficiency of phospholipids and water in soybean oil sediments.

However, when the particle size of soybean oil sediments is too small, there is a risk that soybean oil sediments and water are mixed evenly and homogenized, which destroys the soaking system.

Preferably, the preparation method further comprises adding electrolyte to the soaking system.

More preferably, the mass fraction of the electrolyte in water is 0.01-0.3%.

An appropriate amount of electrolytes is beneficial to the binding of phospholipids and water in soybean oil sediments. Too much electrolyte will inhibit the combination of phospholipid and water, too little or no electrolyte, the water content of self-aggregated hydrous phospholipid will be too high, which will cause energy waste when self-aggregated hydrous phospholipid is dehydrated.

More preferably, the electrolyte includes at least one of acid, base or salt.

More preferably, the electrolyte is at least one of the following components: DL-sodium malic acid, L-malic acid, DL-malic acid, glacial acetic acid, citric acid, potassium citrate, sodium citrate, mono-citric acid Sodium, sodium gluconate, lactic acid, potassium lactate, sodium lactate, potassium carbonate, sodium carbonate, potassium bicarbonate, sodium bicarbonate, sodium sulfate, potassium chloride, potassium hydroxide, sodium hydroxide, hydrochloric acid, phosphoric acid, sodium chloride.

Preferably, the natural sedimentation time is 3-8 h.

As a result of natural settling, self-aggregating hydrous phospholipids are obtained.

After the natural settling, two components, self-aggregated hydrous phospholipids and oil sediment residues, are obtained from the saturated water-absorbing oil sediments.

During the natural settling period, it is not advisable to have stirring operation to prevent emulsification.

The present invention also relates to the application of self-aggregating hydrous phospholipids.

Preferably, the preparation of powdered phospholipids by using self-aggregating aqueous phospholipids includes the following steps:

(1) Preparation of Concentrated Hydrous Phospholipids.

The self-aggregating hydrous phospholipid is concentrated to a water content of 25-65 g/100 g under the conditions of vacuum and 90-110° C. to obtain a concentrated hydrous phospholipid.

The dry-base acetone-insoluble content of concentrated hydrous phospholipids is 92.5-95.5 g/100 g, and the sensory index is brown translucent fluid.

(2) Preparation of Hydrous Phospholipid Elastomers.

The concentrated hydrous phospholipid is pushed into the stirrer at a speed of 10-100 cm/min, the stirring revolution is 800-1200 rpm, and the stirring time is 5-30 s, so as to obtain a continuously output hydrous phospholipid elastomer.

The water content and acetone insoluble content of the hydrous phospholipid elastomer are the same as those of the concentrated hydrous phospholipid, but the sensory indicators change to yellow opaque semi-solid.

The hydrous phospholipid elastomer means that the hydrous phospholipid is an elastomer in the category of colloid chemistry, and its storage modulus G′ is 5-10 times larger than the loss modulus G″, showing strong solid characteristics and weak liquid properties.

(3) Preparation of Solid Phospholipids.

The continuous output of the hydrous phospholipid elastomer is sent into a normal pressure or vacuum continuous dryer through a feed port with a pore diameter of 2-6 mm, and dried at 120-160° C. for 6-20 min to obtain a continuous output of strip solids phospholipids.

The water content of solid phospholipid is 3-10 g/100 g, the content of acetone insoluble matter on dry basis is 92.5-95.5 g/100 g, and the sensory index is yellow strip solid.

(4) Preparation of Powder Phospholipids.

The strip-shaped solid phospholipids are crushed, sieved, and dried under vacuum at 60° C. for 30-60 min to obtain powder phospholipids. The powder phospholipid has a water content of <2 g/100 g, and a dry-base acetone-insoluble content of 92.5-95.5 g/100 g, and the sensory index is yellow powder.

The national standard of the product is “GB28401 Food Additive Phospholipids”.

The water content of the powdered phospholipid in step (4) is equivalent to the drying weight loss described in the national standard “GB28401 Food Additive Phospholipids”.

The vacuum is 0.01-0.004 MPa.

The beneficial effects of the present invention are as follows:

First, the water content of the self-aggregating hydrous phospholipids of the present invention is 70-80 g/100 g, and the water absorption of the phospholipids reaches saturation; at this time, the lipophilicity of the phospholipids is reduced to the minimum, that is, the oil content of the self-aggregating hydrous phospholipids is the smallest, and the purity of the phospholipids is maximum.

The dry acetone insoluble content of self-aggregated hydrous phospholipids reaches 92.5-5.5 g/100 g.

Second, the dry acetone-insoluble content of the self-aggregated hydrous phospholipid of the present invention is 92.5-95.5 g/100 g, while the hydrated phospholipid in the prior art is 90-92 g/100 g, and the liquid crystal phospholipid is 86.05 g/100 g.

Third, the content of acetone-insoluble matter on a dry basis of the self-aggregating hydrous phospholipid of the present invention is the closest to that of the solvent method.

The dry-base acetone-insoluble content of the self-aggregated hydrous phospholipid of the present invention is 92.5-95.5 g/100 g, which has approached or even reached the level of 95-98 g/100 g of solvent-based powdered phospholipids.

From the perspective of industry development, hydration-based powdered phospholipids will eventually replace solvent-based powdered phospholipids and become mainstream products to eliminate environmental pollution caused by organic solvents and potential food safety hazards caused by solvent residues, while reducing production costs.

The self-aggregating hydrous phospholipid of the present invention is currently the most suitable product for replacing solvent-based phospholipid products, and the product does not contain organic solvents.

Fourth, the self-aggregating hydrous phospholipids of the present invention and the powder phospholipids prepared therefrom have a complete process technology from soybean oil sediments to powder phospholipids, and have great advantages in terms of quality, shelf life, production cost, environmental protection and food safety. Therefore, the self-aggregating hydrous phospholipid provided by the present invention is suitable for industrial production.

The method optimizes the process parameters such as the amount of water, the particle size of the dispersed oil sediment particles of the soaking system, temperature and time, so that the water content of the self-aggregated hydrous phospholipid is saturated, and the content of the dry acetone insoluble matter reaches the highest value of the hydration method.

### BRIEF DESCRIPTION OF THE DRAWINGS

FIG. 1 is the process flow chart of soybean oil sediment soaking and natural sedimentation to obtain self-aggregating hydrous phospholipids.

FIG. 2 is a schematic diagram of the process for obtaining self-aggregating hydrous phospholipids by soaking and naturally settling soybean oil sediments.

Wherein:

(a) is a schematic diagram of soybean oil sediment in water;

(b) is a schematic diagram of the soaking system in which soybean oil sediment particles are the dispersed phase and water is the continuous phase;

(c) is a schematic diagram of the self-aggregated hydrous phospholipids that begin to settle naturally in saturated water-absorbing oil sediments;

(d) is a schematic diagram of the self-aggregated hydrous phospholipids and the residues of oil sediments obtained by natural sedimentation of saturated water-absorbing oil sediments.

FIG. 3 is a process flow diagram for preparing solid phospholipids from aggregated hydrous phospholipids.

FIG. 4 is a schematic diagram of the process for preparing solid phospholipids by concentrating hydrous phospholipids.

FIG. 5 is a rheological characteristic diagram of the storage modulus G′ and the loss modulus G″ of the hydrous phospholipid elastomer prepared from the self-aggregated hydrous phospholipid in Application Example 1.

FIG. 6 is a rheological characteristic diagram of the storage modulus G′ and the loss modulus G″ of the hydrous phospholipid elastomer prepared from the self-aggregated hydrous phospholipid in Application Example 2.

Wherein:

(1) is continuous phase, water; (2) is the soybean oil sediment; (3) is the dispersed phase, soybean oil sediment particles; (4) is the saturated water-absorbing oil sediment; (5) is the self-aggregating hydrous phospholipid; (6) is the oil sediment residue; (7) is a concentrated hydrous phospholipid; (8) is a hydrous phospholipid elastomer; (9) is a solid phospholipid.

A is a soaking tank; B is a speed-regulating gear pump; C is a pipeline agitator; D is a continuous dryer.

### DESCRIPTION OF THE EMBODIMENTS

The content of the present invention will be further described below with reference to the accompanying drawings. The experimental methods described in the following examples are conventional methods unless otherwise specified; the reagents and materials can be obtained from commercial sources unless otherwise specified.

The vacuum is 0.01-0.004 MPa.

Definition of acetone-insoluble yield on a dry basis for self-aggregating hydrous phospholipids

(Yield of acetone-insoluble matter on a dry basis for self-aggregating hydrous phospholipids)=(Acetone-insoluble weight on a dry basis of self-aggregating hydrous phospholipids)/(Soybean oil sediment dry basis acetone insoluble weight).

### Example 1

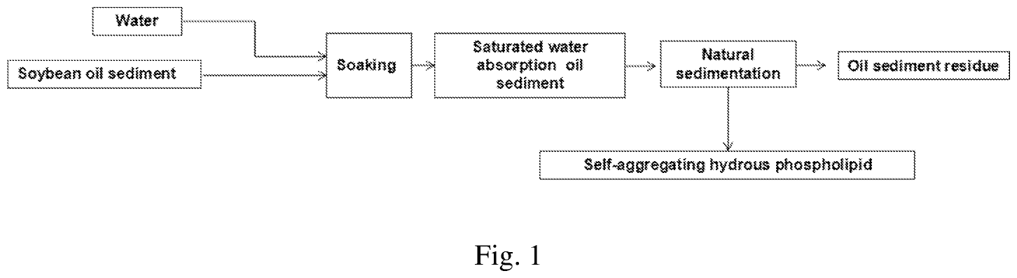

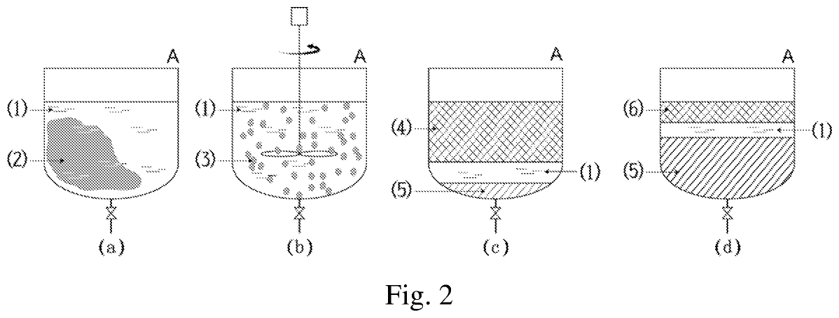

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 60° C. for 3 hours to obtain saturated water-absorbing oil sediment. Saturated water-absorbing oil sediments are prepared when brown self-aggregating hydrous phospholipids appeared.

The soybean oil sediment comes from COFCO Jiayue (Tianjin) Co., Ltd., and its material composition is: water content 41.03 g/100 g, dry basis acetone insoluble content 61.13 g/100 g; the water is drinking water; The mass ratio of oil sediment to water is 1:1; the particle size of the oil sediment particles is 0.3-3 mm.

(2) Natural subsidence. The saturated water-absorbing oil sediments are kept at the soaking temperature, and settled naturally for 3 hours to obtain self-aggregating hydrous phospholipids and oil sediments residues.

The water content of the obtained self-aggregating hydrous phospholipids is 77.78 g/100 g, the content of acetone-insoluble matter on dry basis is 93.81 g/100 g, the sensory index is brown translucent fluid, and the yield of acetone-insoluble matter on dry basis is 75.63%.

### Example 2

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 70° C. for 3 hours to obtain saturated water-absorbing oil sediment. Saturated water-absorbing oil sediments are prepared when brown self-aggregating hydrous phospholipids appeared.

The soybean oil sediment comes from COFCO (Jiujiang) Co., Ltd., and its material composition is: water content 37.56 g/100 g, dry basis acetone insoluble content 60.87 g/100 g; the water is drinking water containing 0.07% sodium chloride by weight; The mass ratio of oil sediment to water is 1:1.5; the particle size of the oil sediment particles is 0.3-3 mm.

(2) Natural subsidence. The saturated water-absorbing oil sediments are kept at the soaking temperature, and settled naturally for 8 hours to obtain self-aggregating hydrous phospholipids and oil sediments residues.

The water content of the obtained self-aggregating hydrous phospholipids is 74.00 g/100 g, the content of acetone-insoluble matter on dry basis is 93.75 g/100 g, the sensory index is brown translucent fluid, and the yield of acetone-insoluble matter on dry basis is 78.09%.

### Example 3

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 80° C. for 2 hours to obtain saturated water-absorbing oil sediment. Saturated water-absorbing oil sediments are prepared when brown self-aggregating hydrous phospholipids appeared.

The soybean oil sediment comes from COFCO (Huanggang) Co., Ltd., and its material composition is: water content 38.42 g/100 g, dry basis acetone insoluble content 61.02 g/100 g; The water is purified drinking water containing 0.05% lactic acid at a concentration of 80%; The mass ratio of oil sediment to water is 1:2; the particle size of the oil sediment particles is 0.3-3 mm.

(2) Natural subsidence. The saturated water-absorbing oil sediments are kept at the soaking temperature, and settled naturally for 4 hours to obtain self-aggregating hydrous phospholipids and oil sediments residues.

The water content of the obtained self-aggregating hydrous phospholipids is 73.12 g/100 g, the content of acetone-insoluble matter on dry basis is 92.53 g/100 g, the sensory index is brown translucent fluid, and the yield of acetone-insoluble matter on dry basis is 80.72%.

### Example 4

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 90° C. for 2 hours to obtain saturated water-absorbing oil sediment. Saturated water-absorbing oil sediments are prepared when brown self-aggregating hydrous phospholipids appeared.

The soybean oil sediment comes from Bunge (Nanjing) Grain and Oil Co., Ltd., and its material composition is: water content 39.78 g/100 g, dry basis acetone insoluble content 62.05 g/100 g; the water is drinking water containing 0.03% sodium hydroxide by weight; The mass ratio of oil sediment to water is 1:2.5; the particle size of the oil sediment particles is 0.3-3 mm.

(2) Natural subsidence. The saturated water-absorbing oil sediments are kept at the soaking temperature, and settled naturally for 5 hours to obtain self-aggregating hydrous phospholipids and oil sediments residues.

The water content of the obtained self-aggregating hydrous phospholipids is 77.56 g/100 g, the content of acetone-insoluble matter on dry basis is 95.42 g/100 g, the sensory index is brown translucent fluid, and the yield of acetone-insoluble matter on dry basis is 82.71%.

### Example 5

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 95° C. for 1 hour to obtain saturated water-absorbing oil sediment. Saturated water-absorbing oil sediments are prepared when brown self-aggregating hydrous phospholipids appeared.

The soybean oil sediment comes from COFCO (Jiujiang) Co., Ltd., and its material composition is: water content 37.69 g/100 g, dry basis acetone insoluble content 63.45 g/100 g; The water is drinking water containing citric acid and sodium chloride, wherein, the added amount of citric acid is 0.028% by weight of water, and the added amount of sodium chloride is 0.052% by weight of water; The mass ratio of oil sediment to water is 1:3; the particle size of the oil sediment particles is 0.3-3 mm.

(2) Natural subsidence. The saturated water-absorbing oil sediments are kept at the soaking temperature, and settled naturally for 6 hours to obtain self-aggregating hydrous phospholipids and oil sediments residues.

The water content of the obtained self-aggregating hydrous phospholipids is 72.33 g/100 g, the content of acetone-insoluble matter on dry basis is 93.65 g/100 g, the sensory index is brown translucent fluid, and the yield of acetone-insoluble matter on dry basis is 83.35%.

### Example 6

A self-aggregating hydrous phospholipid, the preparation process of which is shown in FIG. 1 and (a)-(b) in FIG. 2, includes the following steps:

(1) Soaking. The soybean oil sediment is taken and added to water, and the oil sediment is dispersed in the water into granules by stirring to form a soaking system in which the soybean oil sediment particles are the dispersed phase and the water is the continuous phase.

The soybean oil sediment is soaked at 95° C. for 1 hour to obtain saturated water-absorbing oil sediment. Saturated water-absorbing oil sediments are prepared when brown self-aggregating hydrous phospholipids appeared.

The soybean oil sediment comes from Chinatex Grain and Oil (Dongguan) Co., Ltd., and its material composition is: water content 40.23 g/100 g, dry basis acetone insoluble content 62.39 g/100 g; The water is purified drinking water containing 0.038% citric acid by weight; The mass ratio of oil sediment to water is 1:3.5; the particle size of the oil sediment particles is 0.3-3 mm.

(2) Natural subsidence. The saturated water-absorbing oil sediments are kept at the soaking temperature, and settled naturally for 7 hours to obtain self-aggregating hydrous phospholipids and oil sediments residues.

The water content of the obtained self-aggregating hydrous phospholipids is 73.01 g/100 g, the content of acetone-insoluble matter on dry basis is 94.18 g/100 g, the sensory index is brown translucent fluid, and the yield of acetone-insoluble matter on dry basis is 83.98%.

### Comparative Example 1

A method for preparing hydrated phospholipids from soybean oil sediments, which is derived from a method for preparing hydrated phospholipids from soybean oil sediments disclosed in patent CN107325125A, comprising the following steps:

0.53 times of drinking purified water and 0.03% of sulfuric acid are added to soybean oil sediments, mixed well, and the mixture is heated to 85° C. and kept for 6 hours. Then, centrifuge at 85° C. and 4500 r/min for 5 min to obtain hydrated phospholipids.

The soybean oil sediment is produced by COFCO (Huanggang) Co., Ltd., and its water content is 38.42 g/100 g, the dry acetone-insoluble content is 61.02 g/100 g. The water content of the obtained hydrated phospholipid is 64.03 g/100 g, the content of acetone-insoluble matter on a dry basis is 90.01 g/100 g, and the sensory index is a brown translucent fluid.

The main difference between the present invention and the hydrated phospholipid prepared in Comparative Example 1 includes the following aspects:

First, the hydration method and the water content of the phospholipids are different. Hydrated phospholipids are prepared by a homogeneous hydration method, in which soybean oil sediments and water need to be mixed evenly, and the amount of water added in the hydration operation is 0.25-0.74 times the weight of the oil sediments. Too much water will cause emulsification. Therefore, the water absorption of hydrated phospholipids is far from saturated, and the water content of phospholipids is only 64.03 g/100 g.

The self-aggregating hydrous phospholipid prepared by the present invention is prepared by soaking and hydration method. In the method, soybean oil sediments are in a granular state as a dispersed phase and water is a continuous phase to form a soaking system. In this process, the amount of water added is 1.0-3.5 times the weight of the oil sediment. The phospholipids are saturated with excess free water in the surrounding, with a phospholipid saturation value of 70-80 g/100 g. Only when the water content of phospholipids reaches saturation, the acetone-insoluble content of phospholipids can reach the maximum value of 92.5-95.5 g/100 g.

The water absorption of phospholipids to achieve saturation has the following effects, one is that the acetone-insoluble content of the phospholipids is the highest; the other is that the metal salts of the phospholipids are separated; The third is to facilitate the separation of phospholipids, phospholipid metal salts and oils in oil sediments.

Second, the phospholipid purity is different. The acetone-insoluble content of the hydrated phospholipids is 90-92 g/100 g on a dry basis,

The dry basis acetone-insoluble content of the self-aggregating hydrous phospholipid of the present invention is 92.5-95.5 g/100 g, which is the highest content in the hydration method phospholipid at present, and has approached or even reached the level of 95-98 g/100 g by the solvent method.

### Comparative Example 2

A method for preparing liquid crystal phospholipid from soybean oil sediment, which is derived from the document “Separation and Purification of Soybean Phosphatides in Liquid Crystal Phase”, comprising the following steps:

0.67 times of purified drinking water and soybean oil are mixed evenly, the mixture is heated to 70° C., kept for 4 hours, and then centrifuged at 70° C. and 4500 r/min for 5 minutes to obtain liquid crystal phospholipids.

The soybean oil sediment is produced by China Textile Grain and Oil (Dongguan) Co., Ltd., and its water content is 40.23 g/100 g, the dry acetone-insoluble content is 62.39 g/100 g.

The water content of the obtained liquid crystal phospholipid is 63.89 g/100 g, the content of acetone-insoluble matter on a dry basis is 86.23 g/100 g, and the sensory index is a brown translucent fluid.

The liquid crystalline phospholipid is passed through a circular feed port with a pore diameter of 2 mm, and is placed on a drying tray, and dried in an intermittent vacuum drying oven at 65° C. for 240 min to obtain a brown block solid phospholipid. The water content of solid phospholipid is 6.38 g/100 g, and the content of acetone-insoluble matter on a dry basis is 86.23 g/100 g. The brown solid phospholipid is pulverized, passed through an 18-mesh sieve, and dried in a vacuum drying oven at 60° C. for 30 min to obtain powdered phospholipid. The water content of powder phospholipids is 1.24 g/100 g, the content of acetone-insoluble matter on a dry basis is 86.23%, and the sensory index is brown powder.

Comparing the product of the present invention and the liquid crystal phospholipid of Comparative Example 2, it is found that the differences mainly include the following aspects:

First, the degree of hydration is different. The water content of liquid crystal phospholipids is only 63.89 g/100 g.

Liquid crystal phospholipids are prepared by homogeneous hydration method, in which soybean oil sediments and water need to be mixed evenly, and the amount of water added needs to be strictly controlled, otherwise emulsification will occur. The water uptake of phospholipids is far from reaching saturation. This defect described above is exactly the same as that of hydrated phospholipids.

The self-aggregating hydrous phospholipid prepared by the present invention is prepared by soaking and hydration method. In the method, soybean oil sediments are in a granular state as a dispersed phase and water is a continuous phase to form a soaking system. In this process, the amount of water added is 1.0-3.5 times the weight of the oil sediment. The phospholipids are saturated with excess free water in the surrounding, with a phospholipid saturation value of 70-80 g/100 g. Only when the water content of phospholipids reaches saturation, the acetone-insoluble content of phospholipids can reach the maximum value.

Second, the phospholipid purity is different. The dry acetone-insoluble content of the liquid crystal phospholipids is 86.06 g/100 g, and the phospholipid metal salts could not be removed. The solid phospholipids prepared by drying are light brown, and the powder phospholipids are dark brown.

The acetone-insoluble content on a dry basis of the self-aggregating hydrous phospholipid of the present invention is 92.5-95.5 g/100 g, and the content of the acetone-insoluble matter on a dry basis is quite different.

Both solid phospholipids and powder phospholipids prepared from self-aggregating hydrous phospholipid of the present invention are yellow.

### Comparative Example 3

A preparation method of powdered soybean lecithin, which is derived from patent CN103665029A preparation method of powdered soybean lecithin, comprising the following steps:

(1) Soybean oil sediments and anhydrous acetone are mixed at a weight ratio of 1:10, stirred and extracted under normal pressure and room temperature for 20 minutes, centrifuged for 1 minute with 4000 rpm centrifugal speed, and the solid part is collected.

The soybean oil sediment comes from Bunge (Nanjing) Grain and Oil Co., Ltd., and its material composition is as follows: water content is 39.78 g/100 g, acetone-insoluble content on a dry basis is 62.05 g/100 g.

(2) The solid part obtained in step (1) is mixed with anhydrous acetone at a weight ratio of 1:10, stirred and extracted under normal pressure and room temperature for 20 min, and then centrifuged at a centrifugal speed of 5000 rpm to collect the solid part.

The solid part is crushed and dried under vacuum at 60° C. for 5 hours to obtain soybean powder phospholipid.

The dry acetone-insoluble content of the powdered phospholipid is 95.30 g/100 g, the drying reduction is 0.65 g/100 g, and the color is brown.

Comparing the product of the present invention and the powder phospholipid of Comparative Example 3, it is found that the differences mainly include the following aspects:

First, the difference between environmental protection and food safety:

In Comparative Example 3, a method for preparing powdered phospholipid by a solvent method is provided, in which solvent volatilization will cause pollution to the environment. At the same time, the residual solvent has a potential food safety hazard.

The method for preparing the powdered phospholipid by the product of the present invention belongs to the hydration method, and there is no environmental pollution. The drying reduction of the product is less than or equal to 2 g/100 g, and the drying reduction component is water, and there is no food safety hazard.

Second, the color is different. The powdered phospholipids prepared in Comparative Example 3 could not be freed from phospholipid metal salts. In order to reduce the residual amount of solvent, the drying time of powdered phospholipids during the preparation process is longer, and the color of the product is darker. While, the self-aggregating hydrous phospholipid of the present invention has short drying time when preparing powder phospholipid, and the color of the phospholipid is natural yellow.

### Application 1

The self-aggregating hydrous phospholipids prepared in Example 2 are used in the preparation of solid phospholipids and powdered phospholipids.

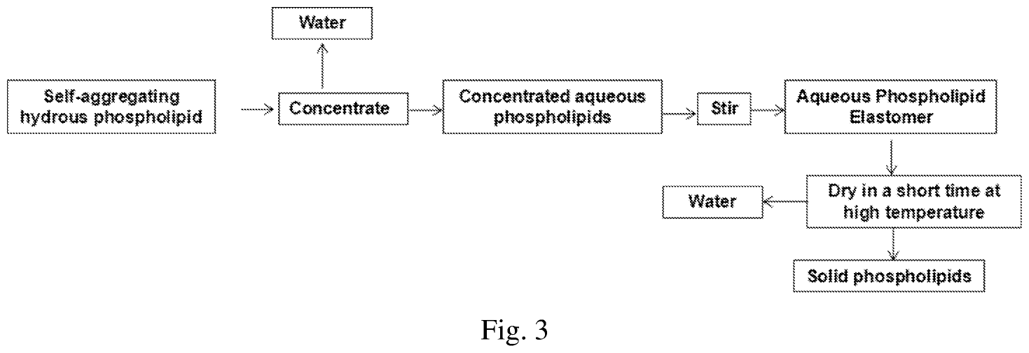

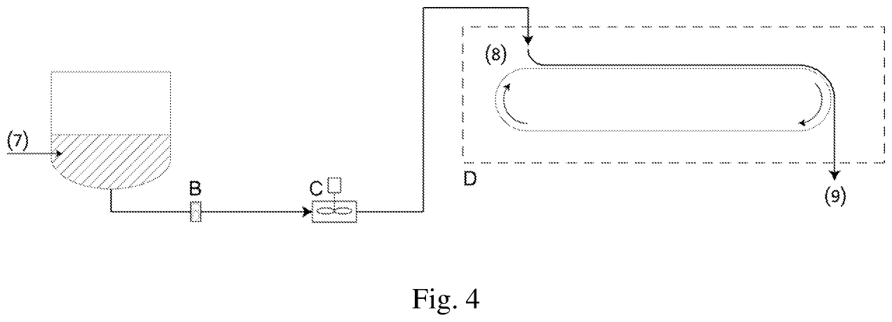

The preparation process is shown in FIG. 3 and FIG. 4, including the following steps:

(1) Concentrating the self-aggregating hydrous phospholipid prepared in Example 2 to obtain a concentrated hydrous phospholipid;

(2) Stirring the concentrated hydrous phospholipid to obtain a hydrous phospholipid elastomer;

(3) Drying the hydrous phospholipid elastomer to obtain a bar-shaped solid phospholipid;

(4) Pulverizing, sieving and drying the strip-shaped solid phospholipids to obtain powdered phospholipids.

In step (1), the self-aggregating hydrous phospholipid of Example 2 is concentrated to 55 g/100 g in a vacuum thin-film evaporator at 95° C. to obtain a concentrated hydrous phospholipid with a dry-base acetone-insoluble content of 93.75 g/100 g, and brown translucent fluid.

In step (2), the concentrated hydrous phospholipid of step (1) is pushed into the mixer at a speed of 80 cm/min, the stirring revolution is 900 rpm, and the stirring time is 10 s to obtain a continuous output hydrous phospholipid elastomer.

The water content and acetone insoluble content of the hydrous phospholipid elastomer are the same as those of the concentrated hydrous phospholipid, but the sensory indicators changed to yellow opaque semi-solid.

In step (3), the hydrous phospholipid elastomer continuously output in step (2) is fed into a continuous atmospheric pressure dryer through a set of feed ports with a pore diameter of 3 mm, and dried at 150° C. for 8 minutes to obtain continuous output strip solids phospholipids. The water content of the strip-shaped solid phospholipid is 7.23 g/100 g, the content of acetone-insoluble matter on a dry basis is 93.75 g/100 g, and the sensory index is a yellow strip-shaped solid.

In step (4), the solid phospholipids in strips of step (3) are pulverized, passed through an 18-mesh sieve, and dried in a double-cone cyclotron vacuum dryer at 60° C. for 40 min to obtain powder phospholipids.

The powder phospholipid has a water content of 1.43 g/100 g, a dry acetone-insoluble content of 93.98 g/100 g. The sensory index is a yellow powder.

The product implements the national standard “GB28401 Food Additive Phospholipids”.

### Application 2

The self-aggregating hydrous phospholipids prepared in Example 4 are used in the preparation of solid phospholipids and powdered phospholipids.

The preparation process is shown in FIG. 3 and FIG. 4, including the following steps:

(1) Concentrating the self-aggregating hydrous phospholipid prepared in Example 4 to obtain a concentrated hydrous phospholipid;

(2) Stirring the concentrated hydrous phospholipid to obtain a hydrous phospholipid elastomer;

(3) Drying the hydrous phospholipid elastomer to obtain a bar-shaped solid phospholipid;

(4) Pulverizing, sieving and drying the strip-shaped solid phospholipids to obtain powdered phospholipids.

In step (1), the self-aggregating hydrous phospholipid of Example 4 is concentrated to 45 g/100 g in a vacuum thin-film evaporator at 105° C. to obtain a concentrated hydrous phospholipid with a dry-base acetone-insoluble content of 95.42 g/100 g, and brown translucent fluid.

In step (2), the concentrated hydrous phospholipid of step (1) is pushed into the mixer at a speed of 40 cm/min, the stirring revolution is 1100 rpm, and the stirring time is 20 s to obtain a continuous output hydrous phospholipid elastomer.

The water content and acetone insoluble content of the hydrous phospholipid elastomer are the same as those of the concentrated hydrous phospholipid, but the sensory indicators changed to yellow opaque semi-solid.

In step (3), the hydrous phospholipid elastomer continuously output in step (2) is fed into a continuous atmospheric pressure dryer through a set of feed ports with a pore diameter of 4 mm, and dried at 130° C. for 15 minutes to obtain continuous output strip solids phospholipids. The water content of the strip-shaped solid phospholipid is 5.32 g/100 g, the content of acetone-insoluble matter on a dry basis is 95.42 g/100 g, and the sensory index is a yellow strip-shaped solid.

In step (4), the solid phospholipids in strips of step (3) are pulverized, passed through an 18-mesh sieve, and dried in a double-cone cyclotron vacuum dryer at 60° C. for 30 min to obtain powder phospholipids.

The powder phospholipid has a water content of 1.18 g/100 g, a dry acetone-insoluble content of 95.42 g/100 g. The sensory index is a yellow powder.

The product implements the national standard “GB28401 Food Additive Phospholipids”.

### Test Example 1

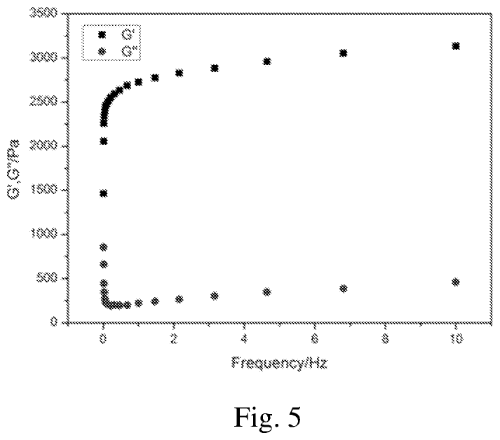

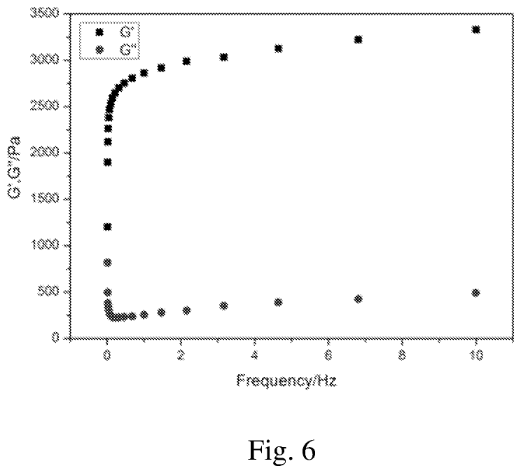

The hydrous phospholipid elastomers prepared in Application Example 1 and Application Example 2 are characterized by rheology, and the test results are shown in FIG. 5 and FIG. 6, respectively.

The instruments and parameters used for testing are: RS6000 rotational rheometer (HAAKE, Germany), Z41Ti coaxial drum sensing system is used for the measuring rotor (the diameters of the drum and the rotor are 43.40 mm and 41.42 mm, respectively). The thickness of the sample in the center of the sensor system is 3 mm.

It can be seen from FIG. 5 and FIG. 6 that the storage modulus G′ is more than 5 times larger than the loss modulus G″ in the measured frequency range of the hydrous phospholipid elastomers provided in Application Example 1 and Application Example 2, which is almost no matter with the frequency of measurement.

The above detailed description is a specific description of one of the feasible embodiments of the present invention, which is not intended to limit the scope of the present invention. Any equivalent implementation or modification that does not depart from the present invention shall be included in the present invention.

What is claimed is:

1. A self-aggregating hydrous phospholipid, wherein the main components of the self-aggregating hydrous phospholipid are phospholipids, oil and water, the water content is 70-80 g/100 g, and the acetone-insoluble content on a dry basis is 92.5-95.5 g/100 g.

2. The self-aggregating hydrous phospholipid according to claim 1, wherein the sensory index of the self-aggregating hydrous phospholipid is a brown translucent fluid.

3. A preparation method of the self-aggregating hydrous phospholipid according to claim 1, comprising the steps of: soaking soybean oil sediments in water to obtain saturated water-absorbing oil sediments, and settling naturally to obtain final product.

4. A preparation method of the self-aggregating hydrous phospholipid according to claim 2, comprising the steps of: soaking soybean oil sediments in water to obtain saturated water-absorbing oil sediments, and settling naturally to obtain final product.

5. The preparation method according to claim 3, wherein the mass ratio of described soybean oil sediment and water is 1:1-3.5.

6. The preparation method according to claim 3, wherein the soaking temperature is 60-95° C., the soaking time is 1-3 h, and the natural sedimentation time is 3-8 h.

7. The preparation method according to claim 3, wherein before the soaking, the soybean oil sediments are dispersed into granules in water by means of stirring, and the particle diameter is less than or equal to 5 mm.

8. The preparation method according to claim 3, wherein the preparation method further comprises adding electrolyte to the soaking system.

9. The preparation method according to claim 4 is wherein the mass ratio of described soybean oil sediment and water is 1:1-3.5.

10. The preparation method according to claim 4, wherein the soaking temperature is 60-95° C., the soaking time is 1-3 h, and the natural sedimentation time is 3-8 h.

11. The preparation method according to claim 4, wherein before the soaking, the soybean oil sediments are dispersed into granules in water by means of stirring, and the particle diameter is less than or equal to 5 mm.

12. The preparation method according to claim 4, wherein the preparation method further comprises adding electrolyte to the soaking system.

13. The preparation method according to claim 8, wherein the mass fraction of the electrolyte in water is 0.01-0.3%, the electrolyte includes at least one of acid, base or salt.

14. The preparation method according to claim 8, wherein the electrolyte is at least one of the following components: DL-sodium malic acid, L-malic acid, DL-malic acid, glacial acetic acid, citric acid, potassium citrate, sodium citrate, mono-citric acid Sodium, sodium gluconate, lactic acid, potassium lactate, sodium lactate, potassium carbonate, sodium carbonate, potassium bicarbonate, sodium bicarbonate, sodium sulfate, potassium chloride, potassium hydroxide, sodium hydroxide, hydrochloric acid, phosphoric acid, sodium chloride.

15. A powder phospholipid, comprising the self-aggregating hydrous phospholipid according to claim 1.

16. A powder phospholipid, comprising the self-aggregating hydrous phospholipid according to claim 2.

17. A powder phospholipid, comprising the self-aggregating hydrous phospholipid prepared by the preparation method according to claim 3.

18. A powder phospholipid, comprising the self-aggregating hydrous phospholipid prepared by the preparation method according to claim 4.

19. A powder phospholipid, comprising the self-aggregating hydrous phospholipid prepared by the preparation method according to claim 5.

20. A powder phospholipid, comprising the self-aggregating hydrous phospholipid prepared by the preparation method according to claim 6.

21. A powder phospholipid, comprising the self-aggregating hydrous phospholipid prepared by the preparation method according to claim 7.

22. A powder phospholipid, comprising the self-aggregating hydrous phospholipid prepared by the preparation method according to claim 8.

23. A powder phospholipid, comprising the self-aggregating hydrous phospholipid prepared by the preparation method according to claim 9.

24. A powder phospholipid, comprising the self-aggregating hydrous phospholipid prepared by the preparation method according to claim 10.

25. A powder phospholipid, comprising the self-aggregating hydrous phospholipid prepared by the preparation method according to claim 11.

26. A powder phospholipid, comprising the self-aggregating hydrous phospholipid prepared by the preparation method according to claim 12.

27. A powder phospholipid, comprising the self-aggregating hydrous phospholipid prepared by the preparation method according to claim 13.

28. A powder phospholipid, comprising the self-aggregating hydrous phospholipid prepared by the preparation method according to claim 14.
